(19) United States
(12) Patent Application Publication
(10) Pub. No.: US 2021/0016696 A1
(43) Pub. Date: Jan. 21, 2021

(54) CONNECTED SEAT CLIP

(71) Applicant: LEAR CORPORATION, Southfield, MI (US)

(72) Inventors: Kathleen Ann KELLY, Weidman, MI (US); Michael WALKOWSKI, Southfield, MI (US); Deborah PATERRA, Rochester, MI (US); Michael LOCKE, Richmond, MI (US)

(21) Appl. No.: 16/909,350

(22) Filed: Jun. 23, 2020

Related U.S. Application Data
(60) Provisional application No. 62/874,209, filed on Jul. 15, 2019.

(51) Int. Cl. B60N 2/58; F16B 2/22

(52) U.S. Cl. CPC B60N 2/5825; F16B 2/22

(57) ABSTRACT

A strip of connected clips for holding a trim cover to a vehicle seat includes a plurality of clips which are attached together via breakaway hinges. Each clip includes a base section attached to a barbed retainer section. Characteristically, individual clips can be broken off the strip while leaving the rest of the strip intact.

### CROSS-REFERENCE TO RELATED APPLICATIONS

This application claims the benefit of U.S. provisional application Ser. No. 62/874,209 filed Jul. 15, 2019, the disclosure of which is hereby incorporated in its entirety by reference herein.

### TECHNICAL FIELD

In at least one aspect, the present invention is related to method for molding clips that attach to vehicle seat covers into foam seat components.

### BACKGROUND

Improving manufacturing processes is a desire of all companies. Process improvement is particularly relevant to the automotive industry, which is under constant pressure to reduce cost. A number of vehicle components are formed from molding processes. For example, vehicle seats include foamed components (e.g., padding). A trim cover typically overlays these components and must be securely held over the foamed component. The molding process that forms these components is one process area where improvements are desired.

### SUMMARY

In at least one aspect, a strip of connected clips for holding a trim cover to a vehicle seat is provided. The strip includes a plurality of clips which are attached together via breakaway hinges. Each clip includes a base section attached to a barbed retainer section. Characteristically, individual clips can be broken off the strip while leaving remaining clips of the strip intact.

In another aspect, a strip of connected clips for holding a trim cover to a vehicle seat is provided. The strip of connected clips includes a plurality of clips arranged in a strip in which adjacent clips are attached together via breakaway hinges. Each clip includes a base section attached to a barbed retainer section extending from a top face of the base section. The base section includes a first section and a second section that extends from opposite sides of the barbed retainer section. Characteristically, individual clips can be broken off the strip of connected clips while leaving remaining clips of the strip of connected clips intact.

In another aspect, a method of making a seat cushion from the strip of connected clips described herein is provided. The method includes steps of attaching one of a plurality of clips on a connected strip of clips to a predetermined position in a foam mold and then breaking the remainder of the connected strip of clips off from the attached clip. Another clip of the connected strip of clips can then be attached to another predetermined position in the foam mold.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIGS. 1A and 1B. Perspective view of a strip of connected clips for holding a trim cover to a vehicle seat.

FIGS. 2A and 2B. Perspective views of a single clip for holding a trim cover to a vehicle seat.

FIG. 3. Cross-section of a clip embedding in a foam component.

FIG. 4. Illustration of a mold operator installing clips in a mold.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” “block”, “random,” “segmented block,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

Throughout this application, where publications are referenced, the disclosures of these publications in their entireties are hereby incorporated by reference into this application to more fully describe the state of the art to which this invention pertains.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

### Abbreviations

“POM” means polyoxymethylene.

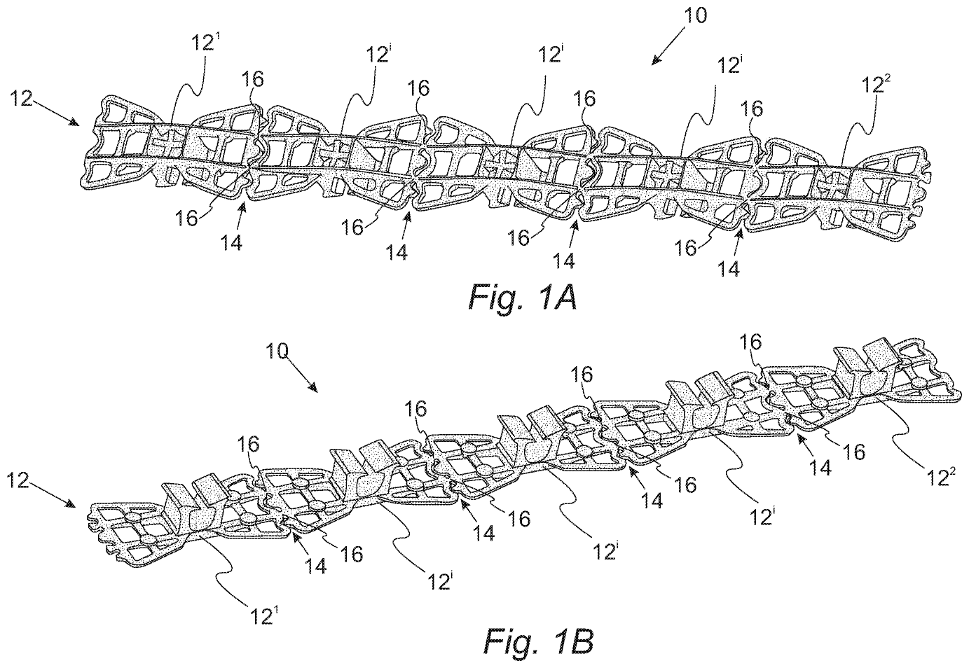

With reference to FIGS. 1A and 1B, perspective views of a strip of connected clips holding a trim cover to a vehicle seat are provided. Clip strip 10 includes a plurality of clips 12 arranged in a strip of clips. The intermediately positioned clips 12ⁱ between end clips 12¹ and 12² are attached together via breakaway hinges 14. Sometimes a breakaway hinge is referred to as a “living hinge.” Breakaway hinges 14 include two or more attachment points 16 at which adjacent hinges are attached together. FIGS. 1A and 1B depict an example where there are two such attachment points between adjacent clips. In a refinement, clip strip 10 includes from about 3 to 10 clips. FIGS. 1A and 1B depict an example where clip strip 10 includes 5 attached clips.

Although the present embodiment is not limited by the material from which clip strip 10 is formed, clip strip 10 is typically composed of a polymer or copolymer, and in particular, a thermoplastic polymer or a thermoplastic copolymer. Examples of suitable polymers that clip strip 10 can be composed of include, but are not limited to, polyoxymethylene (i.e., acetal), poly(methyl methacrylate) (PMMA), acrylonitrile butadiene styrene (ABS), polyamides (e.g., NYLON®), polylactic acid (polylactide), polybenzimidazole, polycarbonate, polyether sulfone, polyetherether ketone, polyetherimide, polyethylene, polyphenylene oxide, polyphenylene sulfide, polypropylene, polystyrene, polyvinyl chloride, polyvinylidene fluoride, polyvinylidene fluoride, polytetrafluoroethylene, and combinations thereof and copolymers thereof. In this regard, a homopolymer or copolymer of polyoxymethylene is particularly useful. In a refinement, the polyoxymethylene copolymer includes about 97 to 99 mole percent —CH₂O— groups (i.e., oxymethylene groups) and about 1 to 3 mole percent —CH₂CH₂O— groups. Alternatively, expressed the polyoxymethylene copolymer is polyoxymethylene with about 1 to 3 percent of the —CH₂O— groups replaced by —CH₂CH₂O— groups. In a further refinement, the polyoxymethylene copolymer includes about 98.5 to 99 mole percent CH₂O groups and about 1 to 1.5 mole percent —CH₂CH₂O— groups (i.e., oxyethylene groups). —CH₂CH₂O— groups. Alternatively, expressed the polyoxymethylene copolymer is polyoxymethylene with about 1 to 1.5 percent of the —CH₂O— groups replaced by —CH₂CH₂O— groups. Moreover, clip strip 10 can be formed by any number of molding processes known to those skilled in the art. Examples of such molding processes include, but are not limited to, injection molding, compression molding, and extrusion.

Referring to FIGS. 1A and 1B, clips 12 are attached to each other via several attachment points 16 that can easily be separated. In this regard, the plastic at the attachment points can be thinner than other sections of the base section or the attachment points can be small (e.g., 1 to 5 mm). Characteristically, individual clips can be broken off the strip while leaving the rest of the strip intact. Therefore, a mold operator can install the clips at various locations in a mold from the strip breaking away the rest of the strip as the clips are positioned.

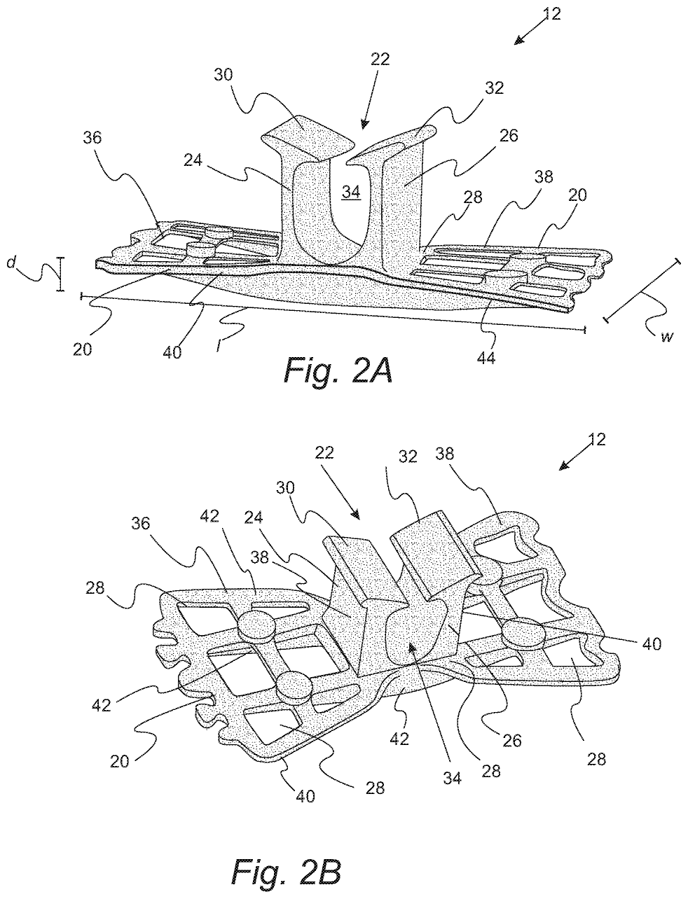

FIGS. 2A and 2B provide illustrations of a single clip. Clip 12 includes base section 20 attached to barbed retainer section 22. Barbed section 22 includes a first protrusion 24 and a second protrusion 26, each of which extends from a top face 28 of base section 20. A first barbed section 30 is positioned at the distal end of first protrusion 24 and a second barbed section 32 is positioned at the distal end of second protrusion 26. First protrusion 24 and second protrusion 26 face each other to define a retention space 34. Each of barbed sections 30 and 32 is inclined downward toward the retention space 34.

Still referring to FIGS. 2A and 2B, base section 20 includes first section 36 and second section 38 that extend from opposite sides of barbed retainer section 22. Therefore, barbed retainer section 22 can be approximately centered with respect to base section 20. In a refinement, base section 20 includes plate component 40 that defines first section 36 and second section 38. In another refinement, at least one rib 42 extends from base section 20 on the bottom face 44 of base section 20 to improve the rigidity of the base section. FIGS. 2A and 2B depict an example having two ribs on a clip. In a refinement, first section 34 and second section 36 each independently fan outwardly from barbed retainer section 10. In a further refinement, first section 34 and second section 36 each independently fan outwardly from barbed retainer section 10 with an angle from about 3 degrees to 15 degrees with respect to a line perpendicular to a face 38 of first protrusion 24 and/or a face 40 of second protrusion 26 of barbed retainer section 22.

Bases section 20 has a length l, width w, and a thickness d. The length l is typically larger than the width w and a thickness d. In particular, length l is typically at least 5 times larger than the thickness d while length l is typically at least 2 times larger than the width w. As used herein, each of length l, width w, and a thickness d represent the spatial extent in the indicated direction. In a refinement, length l, is from about 10 mm to about 50 mm, width w is from about 5 mm to about 25 mm, and thickness d is from about 3 mm to about 10 mm. Each clip of connected clip strip 10 of FIG. 1 is attached to an adjacent clip by attachment points on the edge of base section 20, as set forth above. Base section 20 defines a plurality of openings 28 that assist in anchoring clip 20 to a foam section as depicted below.

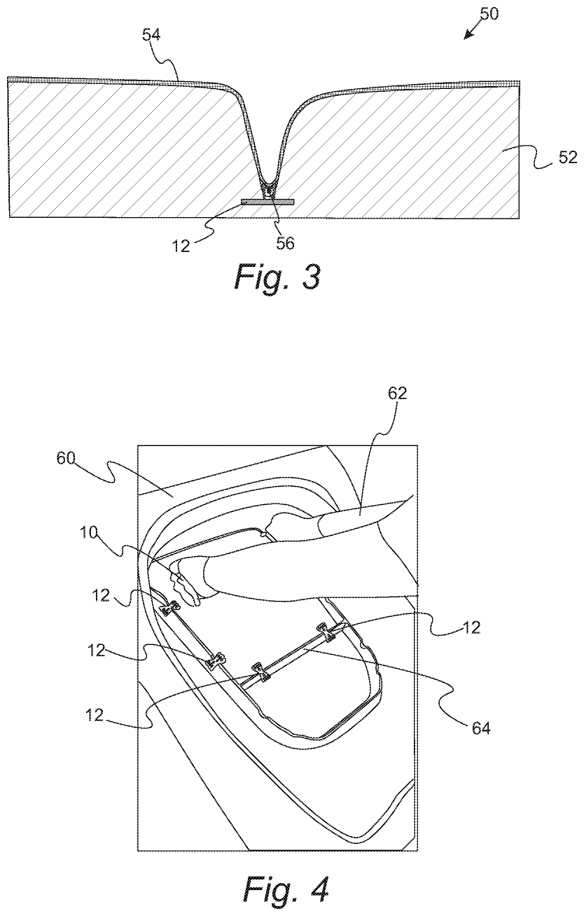

FIG. 3 provides a cross-section of the integration of a clip into a vehicle seat component. Vehicle seat component 50 includes clip 12 embedded into foam section 52. Trim cover 54 is held to foam section 52 by locking protrusion 54 interlocking with clip 12. When foam section 32 is being formed, clips 12 are placed in a mold such that after molding, base section 20 anchors clip 12 to a foam section 52 while barbed retainer section 22 protrudes from foam section 32. The foam will foam within openings 28 of base section 20 to securely hold clip 12 in place.

FIG. 4 provides an illustration of a mold operator installing clips 12 in a mold 60. Mold operator 62 can hold one or more clip strips 10 in his hands. The operator will position the base section 20 over a mold component 64 (the barb retainer section 22 can clip on to the mold component) at a predetermined position in a foam mold. The operator can then break the remainder of clip strip 10 away, leaving a single clip on the mold component. Another clip of the connected strip of clips can then be attached to another predetermined position in the foam mold.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A strip of connected clips for holding a trim cover to a vehicle seat comprising:
a plurality of clips arranged in a strip in which adjacent clips are attached together via breakaway hinges, each clip comprising a base section attached to a barbed retainer section wherein individual clips can be broken off the strip of connected clips while leaving remaining clips of the strip of connected clips intact.

2. The strip of connected clips of claim 1 wherein each clip of the plurality of clips is attached to an adjacent clip by attachment points on an edge of base section.

3. The strip of connected clips of claim 1 wherein intermediately positioned clips between a first end clip and a second end clip are attached together via the breakaway hinges.

4. The strip of connected clips of claim 1 wherein the plurality of clips includes 3 to 10 clips.

5. The strip of connected clips of claim 1 wherein the plurality of clips is composed of a thermoplastic polymer or copolymer.

6. The strip of connected clips of claim 1 the plurality of clips is composed of a thermoplastic polymer selected from the group consisting of polyoxymethylene (i.e., acetal), poly(methyl methacrylate) (PMMA), acrylonitrile butadiene styrene (ABS), polyamides (e.g., NYLON®), polylactic acid (polylactide), polybenzimidazole, polycarbonate, polyether sulfone, polyetherether ketone, polyetherimide, polyethylene, polyphenylene oxide, polyphenylene sulfide, polypropylene, polystyrene, polyvinyl chloride, polyvinylidene fluoride, polyvinylidene fluoride, polytetrafluoroethylene, and combinations thereof.

7. The strip of connected clips of claim 1 wherein the plurality of clips is composed of a copolymer of polyoxymethylene.

8. The strip of connected clips of claim 1 wherein the plurality of clips is formed by injection molding, compression molding, or extrusion.

9. The strip of connected clips of claim 1 wherein the base section has a first section and a second section that extends from opposite sides of the barbed retainer section such that the barbed retainer section is approximately centered with respect to the base section.

10. The strip of connected clips of claim 1 wherein each base section defines a plurality of openings that assist in anchoring clip to a foam section.

11. A strip of connected clips for holding a trim cover to a vehicle seat comprising:
a plurality of clips arranged in a strip in which adjacent clips are attached together via breakaway hinges, each clip comprising a base section attached to a barbed retainer section extending from a top face of the base section, the base section having a first section and a second section that extends from opposite sides of the barbed retainer section, wherein individual clips can be broken off the strip of connected clips while leaving remaining clips of the strip of connected clips intact.

12. The strip of connected clips of claim 11 wherein intermediately positioned clips between a first end clip and a second end clip are attached together via the breakaway hinges.

13. The strip of connected clips of claim 11 wherein the plurality of clips includes 3 to 10 clips.

14. The strip of connected clips of claim 11 wherein the plurality of clips is composed of a thermoplastic polymer or copolymer.

15. The strip of connected clips of claim 11 the plurality of clips is composed of a thermoplastic polymer selected from the group consisting of polyoxymethylene (i.e., acetal), poly(methyl methacrylate) (PMMA), acrylonitrile butadiene styrene (ABS), polyamides (e.g., NYLON®), polylactic acid (polylactide), polybenzimidazole, polycarbonate, polyether sulfone, polyetherether ketone, polyetherimide, polyethylene, polyphenylene oxide, polyphenylene sulfide, polypropylene, polystyrene, polyvinyl chloride, polyvinylidene fluoride, polyvinylidene fluoride, polytetrafluoroethylene, and combinations thereof.

16. The strip of connected clips of claim 11 wherein each base section defines a plurality of openings that assist in anchoring clip to a foam section.

17. A method of making a seat cushion comprising:
attaching one of a plurality of clips on a connected strip of clips to a predetermined position in a foam mold;
breaking the remainder of the connected strip of clips off from the attached clip; and
attaching another clip of the connected strip of clips to another predetermined position in the foam mold.

18. The method of claim 17 wherein adjacent clips are attached together via breakaway hinges, each clip comprising a base section attached to a barbed retainer section wherein individual clips are broken off the connected strip of clips while leaving remaining clips of the strip of connected clips intact.

19. The method of claim 18 wherein the base section has a first section and a second section that extends from opposite sides of the barbed retainer section such that the barbed retainer section is approximately centered with respect to the base section.

20. The method of claim 17 wherein the plurality of clips is composed of a thermoplastic polymer selected from the group consisting of polyoxymethylene (i.e., acetal), poly(methyl methacrylate) (PMMA), acrylonitrile butadiene styrene (ABS), polyamides (e.g., NYLON®), polylactic acid (polylactide), polybenzimidazole, polycarbonate, polyether sulfone, polyetherether ketone, polyetherimide, polyethylene, polyphenylene oxide, polyphenylene sulfide, polypropylene, polystyrene, polyvinyl chloride, polyvinylidene fluoride, polyvinylidene fluoride, polytetrafluoroethylene, and combinations thereof.
